(19) United States
(12) Patent Application Publication
(10) Pub. No.: US 2016/0176401 A1
(43) Pub. Date: Jun. 23, 2016

(54) APPARATUS AND METHOD FOR CONTROLLING A SPEED OF A VEHICLE

(71) Applicant: Bendix Commercial Vehicle Systems LLC, Elyria, OH (US)

(72) Inventor: Andrew J. Pilkington, Avon Lake, OH (US)

(73) Assignee: Bendix Commercial Vehicle Systems LLC, Elyria, OH (US)

(21) Appl. No.: 14/579,153

(22) Filed: Dec. 22, 2014

(51) Int. Cl. B60W 30/14

(52) U.S. Cl. CPC B60W 30/146; B60W 2420/42; B60W 2550/22

(57) ABSTRACT

A controller includes a processor receiving a speed limit signal, based on a current speed limit. The processor also receives an offset information signal. The processor identifies the current speed limit based on the speed limit signal, determines a governed speed limit based on the current speed limit, determines an offset value based on at least one of the current speed limit and the offset information signal, and governs a speed of an associated vehicle to the governed speed limit plus the offset value.

### BACKGROUND

The present invention relates to controlling a speed of a vehicle. It finds particular application in conjunction with governing the speed of a vehicle and dynamically determining an offset speed by which the governed speed may be adjusted, and will be described with particular reference thereto. It will be appreciated, however, that the invention is also amenable to other applications.

When a vehicle travels on a roadway, it is often desirable to limit the speed of the vehicle to a set speed. However, in certain circumstances, it is desirable to permit the speed of the vehicle to exceed the set speed. For example, it may be appropriate to allow the vehicle to exceed the set speed limit by a predetermined amount to facilitate passing a slower moving vehicle.

Governing the speed of a vehicle to a predetermined maximum set speed is currently known. However, in certain circumstances it may be desirable to govern the speed of the vehicle to a posted speed limit and, furthermore, to selectively allow the vehicle speed to exceed the governed posted speed limit by an offset. It is also desirable vary the offset according to different situations.

The present invention provides a new and improved apparatus and method for governing a speed of a vehicle.

### SUMMARY

In one embodiment, a controller includes a processor receiving a speed limit signal, based on a current speed limit. The processor also receives an offset information signal. The processor identifies the current speed limit based on the speed limit signal, determines a governed speed limit based on the current speed limit, determines an offset value based on at least one of the current speed limit and the offset information signal, and governs a speed of an associated vehicle to the governed speed limit plus the offset value.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 illustrates a perspective view of a vehicle on a roadway;

FIG. 2 illustrates a simplified schematic representation of the vehicle including a speed control system in accordance with one embodiment of an apparatus illustrating principles of the present invention;

FIGS. 3-10 illustrate various signs that may be seen along the roadway; and

FIG. 11 is an exemplary methodology of controlling the speed of the vehicle in accordance with one embodiment illustrating principles of the present invention.

### DETAILED DESCRIPTION OF ILLUSTRATED EMBODIMENT

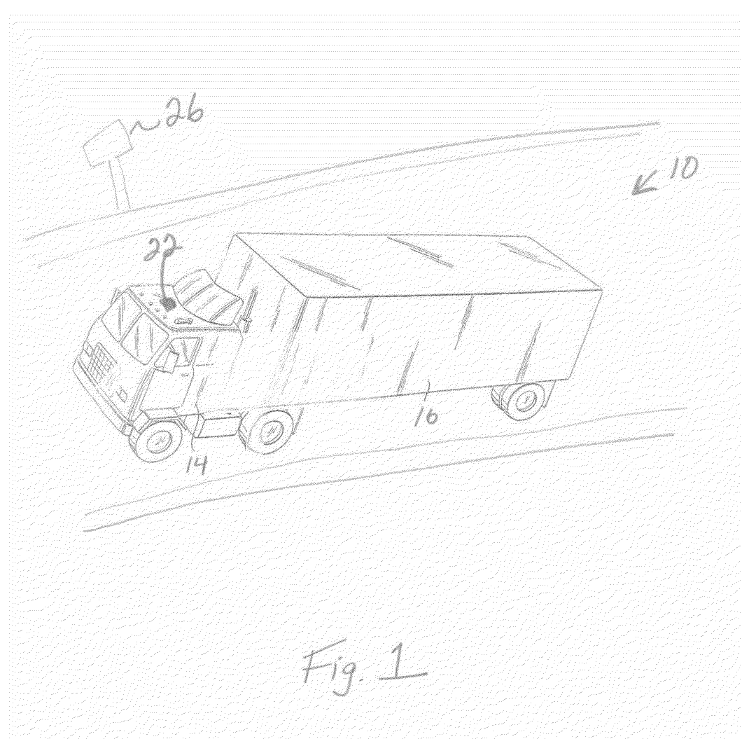

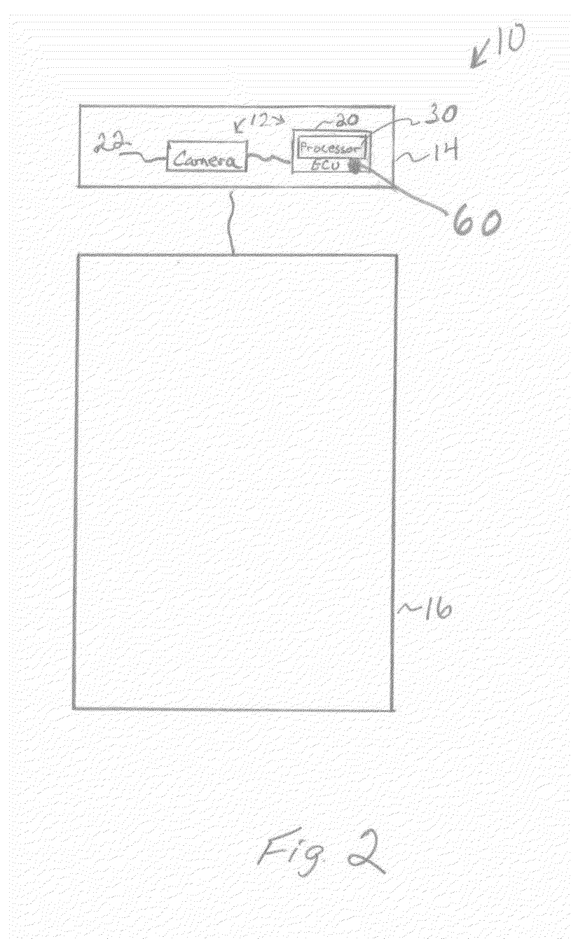

FIG. 1 illustrates a perspective view of a vehicle 10 in accordance with one embodiment of the present invention. In one embodiment, the vehicle 10 is a heavy vehicle such as a truck or bus. FIG. 2 illustrates a simplified component diagram of the vehicle 10 including exemplary components of a speed control system 12 (e.g., a speed governor) in accordance with one embodiment of the present invention.

With reference to FIGS. 1 and 2, the vehicle 10 includes a towing portion 14 and a towed portion 16. The speed control system 12 includes a speed control electronic control unit (ECU) 20 and an image capturing device 22 (e.g., a camera). In one embodiment, the camera 22 is positioned to aim in a forward direction in which the vehicle 10 is traveling.

The camera 22 is capable of receiving images of objects within a peripheral field of view while the vehicle 10 is traveling down a roadway 24. For example, the camera 22 is capable of receiving images of signs 26 either on a left side or right side of the roadway 24 or overhead in front of the vehicle 10 on the roadway 24. Examples of sign images that may be captured by he camera 22 along the roadway 24 include roadway speed limit signs and roadway environment signs. Speed limit signs include indicia indicating a maximum allowable speed vehicles 10 may legally travel along the roadway 24.

Although the posted speed limit is the legal maximum allowable speed, it is not uncommon for drivers to drive in excess of the speed limit without receiving legal infractions. For example, it is not uncommon for drivers to travel 5 miles per hour (mph) over the speed limit without receiving a speeding ticket. Therefore, the speed control system 12 may be programmed to govern the speed of the vehicle 10 to allow the vehicle 10 to travel the posted speed limit plus an offset speed (e.g., 5 mph). In one embodiment, it is desirable to change the offset speed based on the current environment of the vehicle 10.

Environment signs include indicia indicating a current environment along the roadway 24. Different environments may include, for example, particular zones in which extra caution is required while traveling. One example of an environment may be a school zone, which includes school children walking in close proximity to the roadway 24 and crossing the roadway 24. Another environment may be a construction zone, which includes construction workers in relatively close proximity to the roadway 24. In both of these zones, a reduced speed is typically required and strictly enforced.

The camera 22 transmits signals representing the images to the speed control ECU 20. In one embodiment, the camera 22 transmits the signals representing the images to the ECU 20 at predefined time intervals (e.g., every five (5) seconds).Once the signals are received by the ECU 20, a processor 30 receives and processes the signals. Processing the signals involves rendering respective images inside the processor 30 and identifying indicia. The indicia are used to classify the respective images as speed limit signs, environment signs, etc. in that regard, the signals transmitted from the camera 22 that represent signals of roadway speed limit signs are referred to as speed limit signals. Similarly, the signals transmitted from the camera 22 that represent signals of roadway environment signs are referred to as offset information signals.

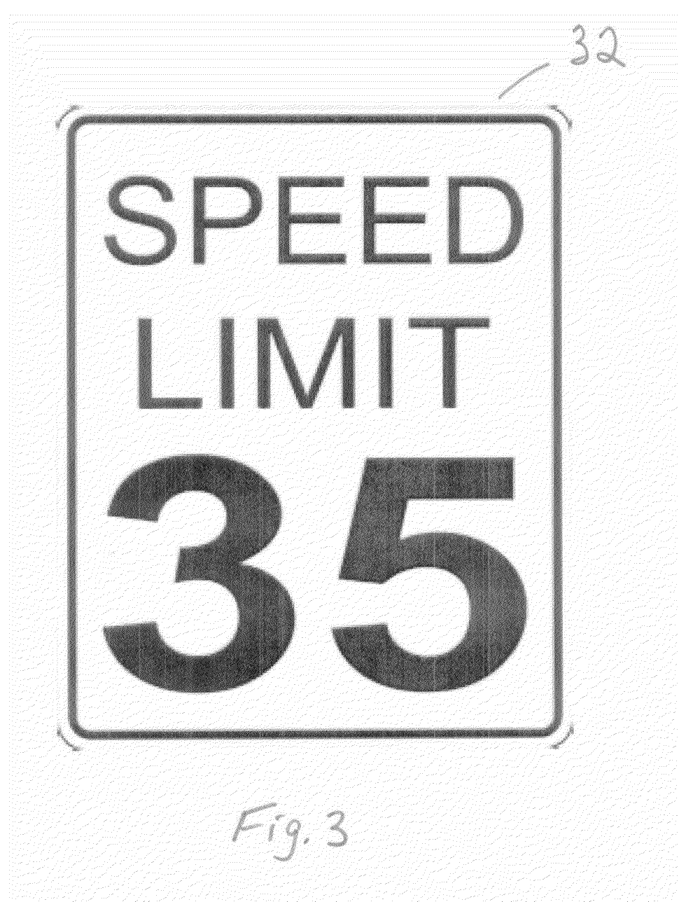

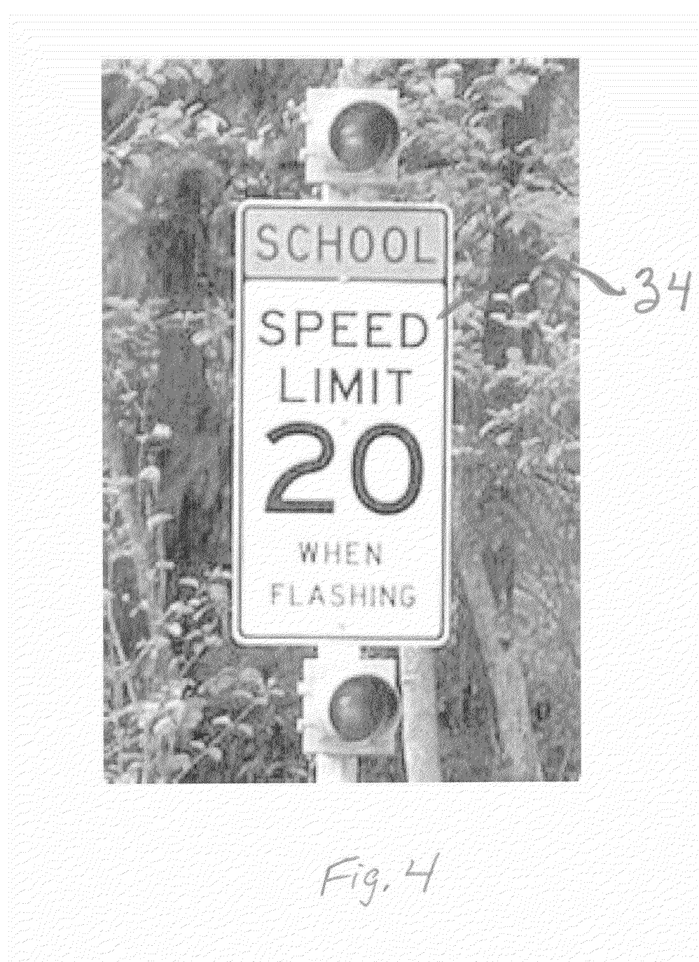

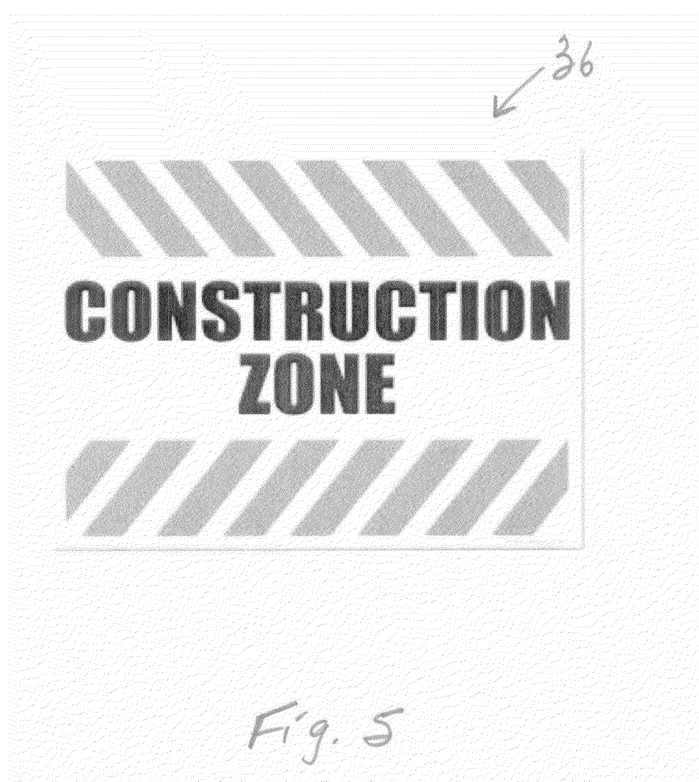

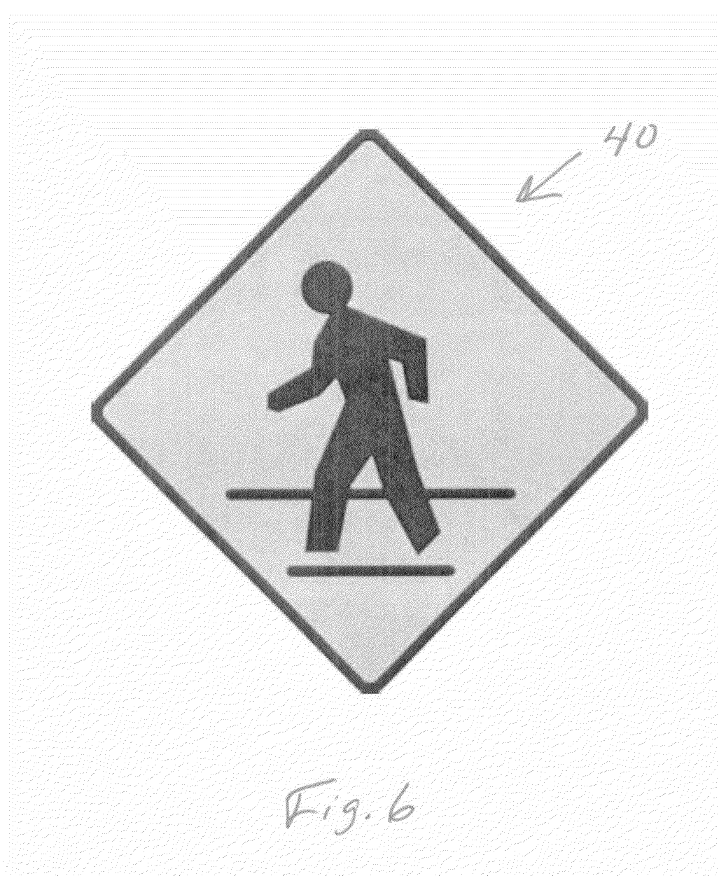

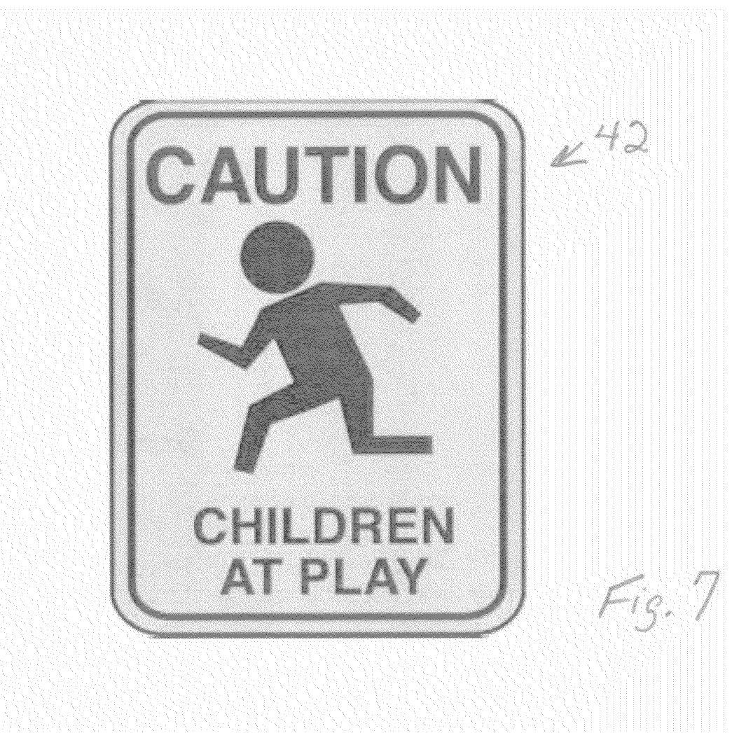

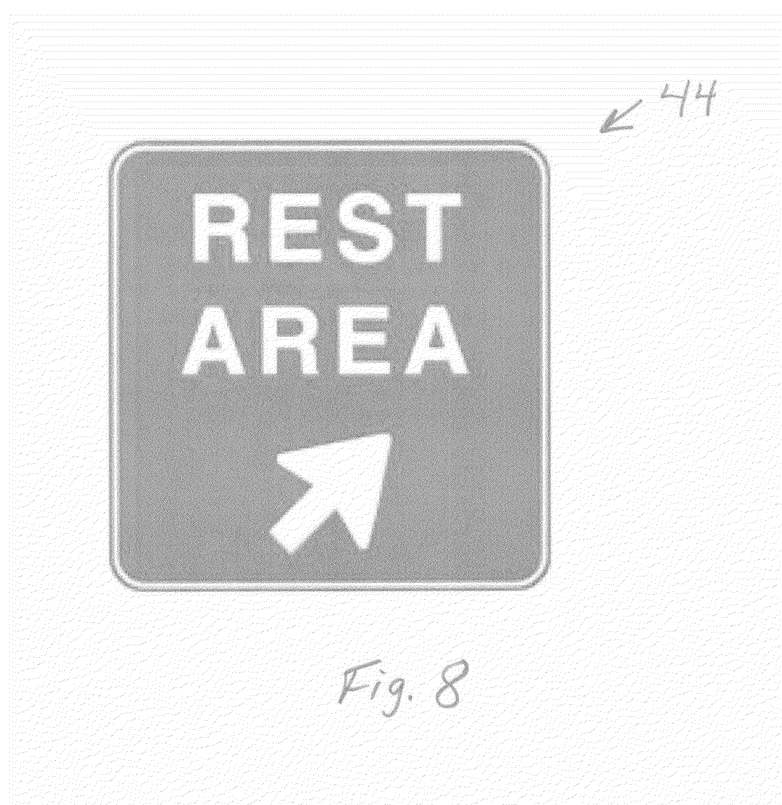

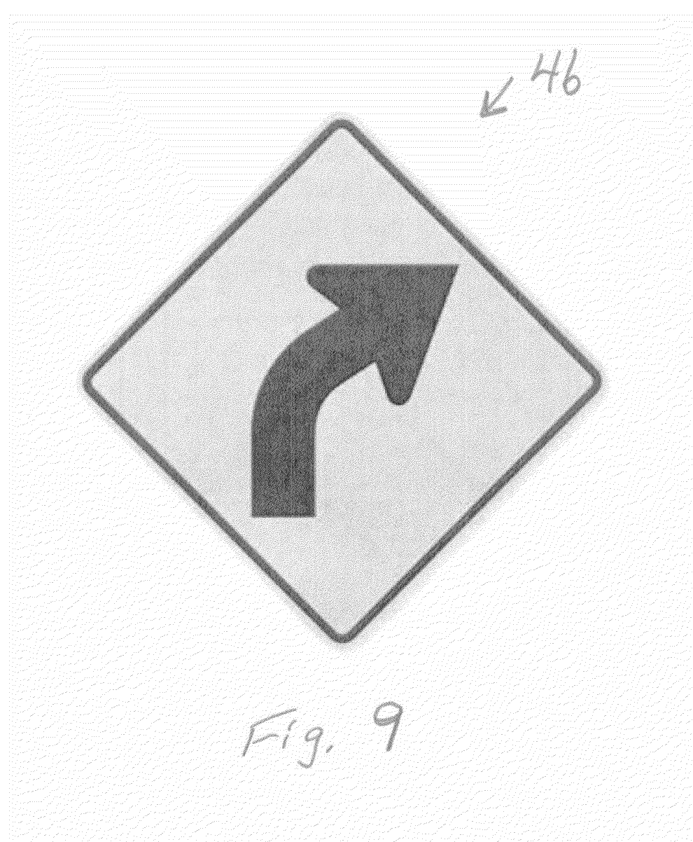

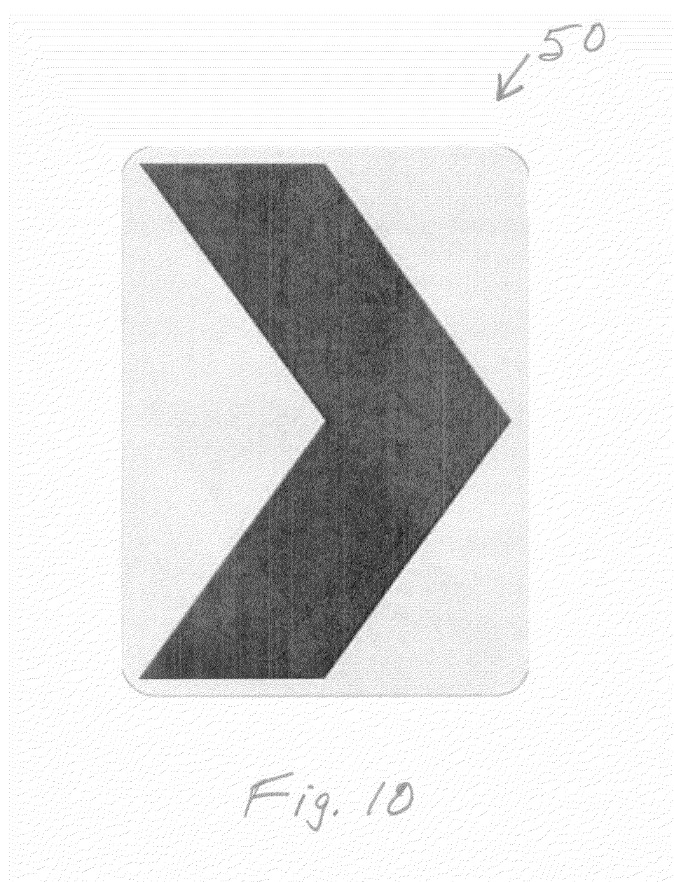

FIG. 3 illustrates an exemplary roadway speed limit sign 32. FIG. 4 illustrates an exemplary roadway environment school zone sign 34. FIG. 5 illustrates an exemplary roadway environment construction zone sign 36. FIG. 6 illustrates an exemplary roadway environment sign indicating a cross walk in a city environment 40. FIG. 7 illustrates an exemplary roadway environment sign indicating a city environment 42. FIG. 8 illustrates an exemplary roadway environment sign indicating a highway environment 44. FIG. 9 illustrates an exemplary roadway environment sign indicating a curve is ahead 46. FIG. 10 illustrates an exemplary roadway environment sign indicating the vehicle is currently in a curve 50. It is to be understood the signs illustrated in FIGS. 3-10 are merely exemplary of various signs that may be used for indicating an environment of a vehicle 10.

With reference to FIGS. 2-10, a lookup table 60 stores features of the signs 32, 34, 36, 40, 42, 44, 46, 50, which are discussed below.

The processor 30 evaluates the images and identifies the respective types of signs 32, 34, 36, 40, 42, 44, 46, 50 based on the indicia included within the various signs. More specifically, the processor 30 compares the indicia in the signs with indicia stored in the lookup table 60 to identify the sign and respective actions to take for each sign. For example, the sign 32 includes the words “SPEED LIMIT” along with a number. Therefore, the processor 30 identifies the sign 32 as a roadway speed limit sign. The sign 34 includes the word “SCHOOL”. Therefore, the processor 30 identifies the sign 34 as a roadway environment sign for a school zone. The sign 36 includes the word “CONSTRUCTION”. Therefore, the processor 30 identifies the sign 36 as a roadway environment sign for a construction zone. The sign 40 indicates a cross-walk. The sign 42 includes the words “CHILDREN” and “PLAY”. Therefore, the processor 30 identifies the sign 42 as a roadway environment sign for a city. The sign 44 includes the word “REST”. Therefore, the processor 30 identifies the sign 44 as a roadway environment sign for a highway. The sign 46 indicates the vehicle 10 is approaching a curve. The sign 50 indicates the vehicle 10 is currently in a curve.

Once the processor 30 identifies a roadway speed limit sign, the processor 30 sets a governed speed of the vehicle (e.g., a governed speed) to the current speed limit identified in the roadway speed limit sign (e.g., 35 mph based on the sign 32). initially, the processor 30 sets an offset value to zero (0) mph. Then, if the processor 30 receives offset information signals representing, for example, any of the signs 34, 36, 42, 44, the processor 30 may adjust the offset value based on the environment sign defined by the offset information signals. The processor 30 will then add the offset value (e.g., offset speed) to the governed speed to allow the vehicle 10 to travel a maximum speed, which is the governed speed plus the offset speed.

For example, if the processor 30 receives offset information signals indicating indicia for the school zone sign 34, the processor 30 determines if a speed limit is identified on the sign. In the present example, the sign 34 identifies a speed limit of twenty (20) mph. Therefore, the processor 30 sets the governed speed limit to twenty (20) mph, Furthermore, since the vehicle 10 is in school zone, the processor 30 sets the offset value to zero (0) mph.

In another example, if the processor 30 receives offset information signals indicating indicia for the construction zone sign 36, the processor 30 determines if a speed limit is identified on the sign. In the present example, the sign 36 does not identify a particular speed limit. Therefore, the processor 30 maintains the governed speed limit as the current speed limit identified in the most recent speed limit sign. Furthermore, since the vehicle 10 is in construction zone, the processor 30 sets the offset value to either zero (0) mph or a negative value (e.g., −5 mph). A negative offset value added to the governed speed results in the maximum speed of the vehicle 10 being the governed speed reduced by the offset value. For example, if the governed speed is 60 mph and the offset value is −5 mph, the maximum speed of the vehicle is 60 mph−5 mph=55 mph.

A decision to set the offset value to either zero (0) mph or a negative value (e.g., −5 mph) is made at a time when the processor 30 is programmed by a user, In one embodiment, the processor 30 is programmed by a user prior to being installed in the vehicle 10. It is also contemplated that the processor 30 is programmed, or reprogrammed, by a user at any time after being installed in the vehicle 10.

In another example, if the processor 30 receives offset information signals indicating indicia for the cross-walk sign 40, the processor 30 maintains the governed speed limit as the current speed limit identified in the most recent speed limit sign. Furthermore, since the vehicle 10 is in a general city area, the processor 30 sets the offset value to five (5) mph.

In another example, if the processor 30 receives offset information signals indicating indicia for the “Children at Play” sign 42, the processor 30 maintains the governed speed limit as the current speed limit identified in the most recent speed limit sign. However, since the vehicle 10 is in a city area with children, the processor 30 sets the offset value to either zero (0) mph or −5 mph.

In another example, if the processor 30 receives offset information signals indicating indicia for a highway sign 44, the processor 30 maintains the governed speed limit as the current speed limit identified in the most recent speed limit sign. Furthermore, since the vehicle 10 is in a general highway area, the processor 30 sets the offset value based on the current speed limit. For example, the processor 30 sets the offset value to 10% of the current speed limit. In this manner, the processor 30 dynamically changes the offset value based on the current speed limit. In other words, if the speed limit is 60 mph, the processor 30 sets the offset value to 6.0 mph; if the speed limit is 70 mph, the processor 30 sets the offset value to 7.0 mph.

In another example, if the processor 30 receives offset information signals indicating indicia for a curve ahead sign 46, the processor 30 maintains the governed speed limit as the current speed limit identified in the most recent speed limit sign. Furthermore, since the vehicle 10 is approaching a curve, the processor 30 sets the offset value to either zero (0) mph or a negative value (e.g., −5 mph).

In another example, if the processor 30 receives offset information signals indicating indicia that the vehicle 10 is currently in a curve 46, the processor 30 maintains the governed speed limit as the current speed limit identified in the most recent speed limit sign. Furthermore, since the vehicle 10 is currently in a curve, the processor 30 sets the offset value to a negative value (e.g., −5 mph) to slow down the vehicle 10.

It is also contemplated that the processor 30 controls the offset value based on a status of the vehicle 10. For example, if the processor 30 determines windshield wipers of the vehicle 10 are activated for a predetermined time (e.g., 5 minutes), it is assume the roadway 24 is wet. Therefore, the processor 30 sets the offset value to either zero (0) mph or −5 mph. Similarly, if the processor 30 determines an antilock braking event has occurred, the processor 30 sets the offset value to either zero (0) mph or −5 mph.

In another embodiment, it is contemplated that the processor 30 initially sets the offset value to a predetermined value (e.g., either 5 mph or 10% of the governed speed). in this embodiment, the processor 30 only allows the speed of the vehicle 10 to exceed the governed speed, up to the speed associated with the offset value, for a predetermined time. For example, if the governed speed is 60 mph and the offset value is 6 mph (e.g., 10% of the governed speed), the processor would allow the driver to exceed the 60 mph governed speed for only a predetermined time (e.g., 5 minutes) to facilitate passing another vehicle on the roadway 24. If a driver does not reduce a speed of vehicle 10 to the governed speed (e.g., 60 mph) within a predetermined time of exceeding the governed speed (e.g., to pass another vehicle), the processor 30 automatically reduces the offset value to zero (0) (or another value) after the predetermined time.

In the embodiments described above, the speed control system 12 is an electronic system that acts to govern (e.g., limit) the speed of the vehicle 10. Therefore, the speed control system 12 is referred to as an electronic speed governor for the vehicle 10.

From the discussion above, it is clear that the camera 22 acts as a means for receiving an image of a roadway speed limit sign 32 and an image of roadway environment signs 34, 36, 40, 42, 44, 46, 50. In addition, the processor 30 acts as a means for governing a speed of the vehicle 10 to the governed speed limit plus the offset value.

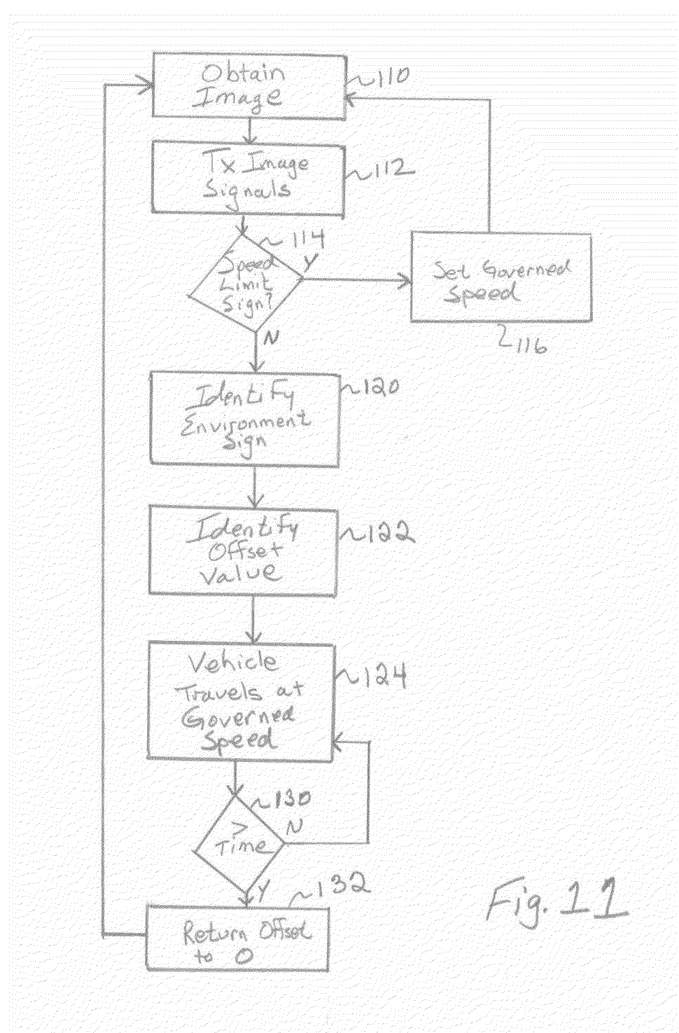

With reference to FIG. 11, an exemplary methodology of the system shown in FIGS. 1-10 for controlling a speed of a vehicle is illustrated. As illustrated, the blocks represent functions, actions and/or events performed therein. It will be appreciated that electronic and software systems involve dynamic and flexible processes such that the illustrated blocks and described sequences can be performed in different sequences. it will also be appreciated by one of ordinary skill in the art that elements embodied as software may be implemented using various programming approaches such as machine language, procedural, object-oriented or artificial intelligence techniques. It will further be appreciated that, if desired and appropriate, some or all of the software can be embodied as part of a device's operating system.

With reference to FIGS. 1-11, the camera 22 obtains an image of a sign (e.g., 32, 34, 36, 40, 42, 44, 46, 50) in a step 110. The camera transmits signals representing the image to the processor 30 in step 112. In a step 114, the processor 30 determines if the image is of a roadway speed limit sign (e.g., 32). If it is determined in the step 114 that the image is of a roadway speed limit sign, control passes to a step 116 for setting the governed speed of the vehicle 10 to the speed limit identified in the sign before returning to the step 110. Otherwise, if it is determined in the step 114 that the image is not of a roadway speed limit sign, control passes to a step 120 for identifying the roadway environment sign (e.g., 34, 36, 40, 42, 44, 46, 50).

Then, in a step 122, the processor 30 identifies the offset value (offset speed) based on the roadway environment sign identified in the step 120. The processor 30 allows the vehicle 10 to travel at the governed speed plus the offset speed in a step 124.

Optionally, in a step 130, the processor 30 determines if the vehicle 10 has traveled above the governed speed, but still within the offset speed, for a predetermined time. Hit is determined in the step 130 that the vehicle 10 has not traveled above the governed speed for the predetermined time, control returns to the step 124. If, on the other hand, it is determined in the step 130 that the vehicle 10 has traveled above the governed speed for the predetermined time, control passes to a step 132 for returning the offset value (e.g., offset speed) to zero (0) mph.

Next, control returns to the step 110.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I/we claim:

1. A controller, comprising:
a processor receiving a speed limit signal, based on a current speed limit, and receiving an offset information signal, the processor identifying the current speed limit based on the speed limit signal, determining a governed speed limit based on the current speed limit, determining an offset value based on at least one of the current speed limit and the offset information signal, and governing a speed of an associated vehicle to the governed speed limit plus the offset value.

2. The controller as set forth in claim 1, wherein the processor sets the governed speed limit to be the identified current speed limit.

3. The controller as set forth in claim 1, wherein:
the processor receives the speed limit signal as an image of a roadway speed limit sign.

4. The controller as set forth in claim 3, wherein:
the processor determines the current speed limit based on an evaluation of the image of the roadway speed limit sign.

5. The controller as set forth in claim 1, wherein:
the processor receives the offset information signal as an image of a roadway environment sign; and
the processor determines the offset value based on an evaluation of the image of the roadway environment sign.

6. The controller as set forth in claim 5, wherein:
if the roadway environment sign indicates the associated vehicle is in a school zone, the processor determines the offset value to be one of zero (0) mph and a negative value;
if the roadway environment sign indicates the associated vehicle is in a construction zone, the processor determines the offset value to be one of zero (0) mph and a negative value; and
if the roadway environment sign indicates the associated vehicle is one of approaching and in a curve, the processor determines the offset value to be one of zero (0) mph and a negative value.

7. The controller as set forth in claim 6, wherein:
if the roadway environment sign indicates the associated vehicle is in a general city zone, the processor determines the offset value to be five (5) mph; and
if the roadway environment sign indicates the associated vehicle is in a highway zone, the processor determines the offset value to be 10% of the current speed limit.

8. The controller as set forth in claim 5, wherein:
the processor obtains the offset value from a lookup table based on the evaluation of the image of the roadway environment sign.

9. The controller as set forth in claim 1, wherein the processor reduces the offset value to zero (0) if at least one of windshield wipers of the associated vehicle are activated for a predetermined time and an antilock braking event occurs.

10. The controller as set forth in claim 1, wherein:
the processor sets the offset value to zero (0) mph a predetermined time after an actual speed of the vehicle is the governed speed plus the offset value.

11. A system for controlling a speed, the system comprising:
a camera capable of receiving an image of a roadway speed limit sign and an image of a roadway environment sign, the camera transmitting the image of the roadway speed limit sign as a speed limit signal and transmitting the image of the roadway environment sign as an offset information signal; and
a processor receiving the speed limit signal and the offset information signal, the processor identifying the current speed limit based on the speed limit signal, determining a governed speed limit based on the current speed limit, determining an offset value based on the offset information signal, and governing a speed of an associated vehicle to the governed speed limit plus the offset value.

12. The system for controlling a speed as set forth in claim 11, wherein:
the camera receives the image of a roadway speed limit sign and the image of a roadway environment sign at predefined time intervals.

13. The system for controlling a speed as set forth in claim 11, wherein:
the processor dynamically changes the offset value based on a status of the associated vehicle.

14. The system for controlling a speed as set forth in claim 13, wherein:
the status of the vehicle is based on at least one of an activation of windshield wipers of the associated vehicle for a predetermined time and an occurrence of an antilock braking event.

15. The system for controlling a speed as set forth in claim 11, wherein:
the processor dynamically changes the offset value based on the current speed limit.

16. The system for controlling a speed as set forth in claim 11, wherein:
if the roadway environment sign indicates the associated vehicle is in a school zone, the processor determines the offset value to be one of zero (0) mph and a negative value;
if the roadway environment sign indicates the associated vehicle is in a construction zone, the processor determines the offset value to be one of zero (0) mph and a negative value; and
if the roadway environment sign indicates the associated vehicle is one of approaching and in a curve, the processor determines the offset value to be one of zero (0) mph and a negative value.

17. The system for controlling a speed as set forth in claim 11, wherein:
if the roadway environment sign indicates the associated vehicle is in a general city zone, the processor determines the offset value to be five (5) mph; and
if the roadway environment sign indicates the associated vehicle is in a highway zone, the processor determines the offset value to be 10% of the current speed limit.

18. A method for controlling a speed of a vehicle, the method comprising:
identifying a current speed limit based on an image of a roadway speed limit sign;
determining a governed speed limit based on the current speed limit;
determining an offset value based on an image of a roadway environment sign; and
governing a speed of the vehicle to within the offset value of the governed speed limit.

19. The method for controlling a speed of a vehicle as set forth in claim 18, wherein the step of determining the offset value includes:
if the roadway environment sign indicates the associated vehicle is in a school zone, determining the offset value to be one of zero (0) mph and a negative value;
if the roadway environment sign indicates the associated vehicle is in a construction zone, determining the offset value to be one of zero (0) mph and a negative value; and
if the roadway environment sign indicates the associated vehicle is one of approaching and in a curve, determining the offset value to be one of zero (0) mph and a negative value.

20. The method for controlling a speed of a vehicle as set forth in claim 18, wherein the step of determining the offset value includes:
if the roadway environment sign indicates the associated vehicle is in a general city zone, determining the offset value to be five (5) mph; and
if the roadway environment sign indicates the associated vehicle is in a highway zone, determining the offset value to be 10% of the current speed limit.

21. The method for controlling a speed of a vehicle as set forth in claim 18, further including:
if the offset value is positive, setting the offset value to zero (0) mph a predetermined time after an actual speed of the vehicle is the governed speed plus the offset value.

22. A system for controlling a speed, the system comprising:
means for receiving an image of a roadway speed limit sign and an image of a roadway environment sign, the means for receiving transmitting the image of the roadway speed limit sign as a speed limit signal and transmitting the image of the roadway environment sign as an offset information signal;
a processor receiving the speed limit signal and the offset information signal, the processor identifying the current speed limit based on the speed limit signal, determining a governed speed limit based on the current speed limit, and determining an offset value based on the offset information signal; and
means for governing a speed of an associated vehicle to the governed speed limit plus the offset value.
